(19) United States
(12) Patent Application Publication
(10) Pub. No.: US 2018/0285100 A1
(43) Pub. Date: Oct. 4, 2018

(54) A method of refactoring Android applications for smart watches

(71) Applicant: Peking University, Beijing (CN)

(72) Inventors: Gang Huang, Beijing (CN); Xuanzhe Liu, Beijing (CN); Meihua Yu, Beijing (CN); Yun Ma, Beijing (CN); Yi Liu, Beijing (CN); Mengwei Xu, Beijing (CN)

(21) Appl. No.: 15/746,439

(22) PCT Filed: Sep. 7, 2016
(86) PCT No.: PCT/CN2016/098295

§ 371 Date: Jan. 22, 2018

(30) Foreign Application Priority Data
Dec. 24, 2015 (CN) 201510983203.1

(51) Int. Cl. G06F 8/72; G06F 8/36; G06F 8/38

(52) U.S. Cl. CPC G06F 8/72; G06F 8/38; G06F 8/36

(57) ABSTRACT

The present invention discloses a method of refactoring Android applications for smart watches. The present method includes: 1) for a given Android application, creating an empty folder Mobile, migrating source codes of the Android application to the Mobile folder, and generating a Wear module in a root of the Android application; 2) adding codes to support smart watch features in the Wear module, and adding a watch-specific dependency library; copying the source codes of the Android application to the Wear module; 3) replaced API in the Wear module with API for watch applications; and 4) reducing page layout of the Android application by a reduction ratio corresponding to size ratio of a smart phone to a smart watch; identifying all view components on a page of the Android application, reducing down to a dimension of each of the view components to fit a screen width of the smart watch, and sorting the view components based on priorities. The disclosed method reduces the development and maintenance costs for smart watch applications.

### TECHNICAL FIELD

The present invention relates to a method of refactoring Android applications for smart watches, which utilizes program analysis and refactoring technology to refactor Android applications developed for smart phones into applications suitable for smart watches, and belongs to the technical field of software.

### BACKGROUND OF THE INVENTION

“2015 status and future prospects analysis of the smart watch industry development in China” shows: smart watches will become another epoch-making product in consumer electronics after the era led by iPad tablet computers. The current mainstream smart watches include Apple Watch installed with Watch OS, and Gear, LG, and Moto360 installed with Android Wear system, and so on. In the case of Android Wear, the application of smart watches is still relatively scarce, and most Android applications cannot be easily ported because smart watches have small screen sizes, different ways of interactions with mobile phones, and a more tightly integrated sensor.

The most straightforward solution to the above problem is to redevelop a completely new App for smart watches. Based on the official Google Android Wear development documents and its recommended design, developers can re-create a smart watch version application that matches the smart phone's screen size, operation and communication methods. Although this approach guarantees the application experience, there are also two problems: on one hand, the re-development of smart-watch applications is costly for personal or small and medium-sized enterprises; on the other hand, when the application content needs to be modified, one must modify both versions of Android and Android Wear applications at the same time, which will increase maintenance costs.

Thus, although the re-development of a smart-watch version of the application enables good user experience, but the development and maintenance costs are greater. Therefore, semi-automatically converting existing Android mobile applications to smart watch applications is a technical issue worthy of study.

### SUMMARY OF THE INVENTION

An object of the present invention is to provide a method of refactoring Android applications for smart watches. The key ideas include: to provide a semi-automatic conversion technologies for the owners of existing Android phone applications (hereinafter referred to as the developer) at the time of refactoring, to refactor smart-phone Android applications to smart watch Android Wear applications. According to descriptions on Google Android Wear official website, an Android Wear smart-watch application includes a Mobile module on the phone side and a Wear module on the watch side. This method achieves fast cost-effective development by migrating user-specified functions from the phone side to the Wear module and repackaging to create a smart watch application comprising a Wear module.

The technical scheme of the invention is as follows:

A method of refactoring Android applications for smart watches. The specific steps of the refactoring process include:

1) Automatic adjustment of application structure. The source code structure in Android Wear includes an additional Wear module (folder) running on the watch side compared to Android Application. The present method implements refactoring based on the source codes of existing Android application. First, using Android Studio tool to open a project of the existing Android application (assumed to be A_Project), creating an empty folder Mobile, migrating source codes of the Android application to the Mobile Module (folder), and then using the project Script in the root directory to call new module function in AndroidStudio to automatically generate an empty Wear module (folder) that contains only a watch page of empty Activity; writing a script to automatically modify the AndroidManifest.xml file in the src directory in the Wear module, adding watch feature support (specifically, adding code <uses-feature android: name=“android.hardware.type.watch”/>); writing a script to modify the build.gradle file to add a watch-specific dependency file (dependencies:com.google.android.support:wearable and com.google.android.gms: play-services-wearable); scripting to copy the source codes of the original Android application to the src directory in the Wear module.

2) Automatic adjustment of Application Programming Interface (API). This method uses the technologies of program analysis and refactoring to determine the API calls to the underlying Android system by the original Android application copied in to the Wear module, replacing API in source codes of the original Android application copied into the Wear module by an API suitable for Android Wear for smart watches; the API that have unique characteristics on some mobile phones are replaced by remote calling method (e.g. via Bluetooth communication), by calling the corresponding method in the Mobile module (folder) on the mobile phone side and receiving a return value.

3) Automatic adjustment of application user interface layout. The displays of common smart watches have round and square shapes. The present method provides a variety of automated adaptation options for developers to choose from. The easiest method is to reduce page layout of the Android application by a reduction ratio corresponding to size ratio of a smart phone to a smart watch. Although this method is sufficient for application having fewer view components, when there are more view components on a page, some view components may be reduced to too small sizes on the page, which may affect operations and user perception experience. Therefore, the presently disclosed method also provides two other adaptation options: a list format or a stack of cards. Both options first identify all the view components on the page, such as lists, grids, paragraphs, tables, pictures, buttons, etc., reduce each view component to fit the width of the smart watch's screen, and provide a default priority sorting based on content relevance. The list adaption method arranges suitable view components vertically in a table according to the priority sorting, to generate the overall watch application page. The card adaption method arranges view components in a stack of cards based on the priority sorting.

4) Manual adjustments to application parameter values and to the page layout. This method supports manual adjustments to parameter values of the page layout and to the page layout in Android application in a WYSIWYG manner and the form of Android Studio plug-in. In the above automatic API replacement and page layout adaptation, the conversion result may not be fully satisfactory to the developers. For example, after the API replacement, the number of parameters may be changed, the parameter values may be adjusted, and the page automation adaptation control may be identified incorrectly. The developers may also change the adaption program. In the manual adjustment phase, developers can modify the values used in the program including values.xml and the parameters involved in the API replacement described in the above steps, making the converted interface more suitable for the smart watch screens. The developers can also manually change the adaptation result of the page layout, and adjust the order of view components on the details of the adaptation result.

Compared with the prior art, the present invention has the following positive effects:

The present invention provides a semi-automatic method to refactor Android applications into the smart watch applications, while ensuring good conversion quality and high conversion efficiency, which reduces the development and maintenance costs of smart watch applications.

### BRIEF DESCRIPTION OF THE DRAWINGS

FIG. 1 is a flow chart of the method of the present invention.

FIGS. 2A and 2B show a page of 2048 game application: FIG. 2A: application page for a smart phone; and FIG. 2B: application page for a smart watch.

### DETAILED DESCRIPTION OF IMPLEMENTIONS

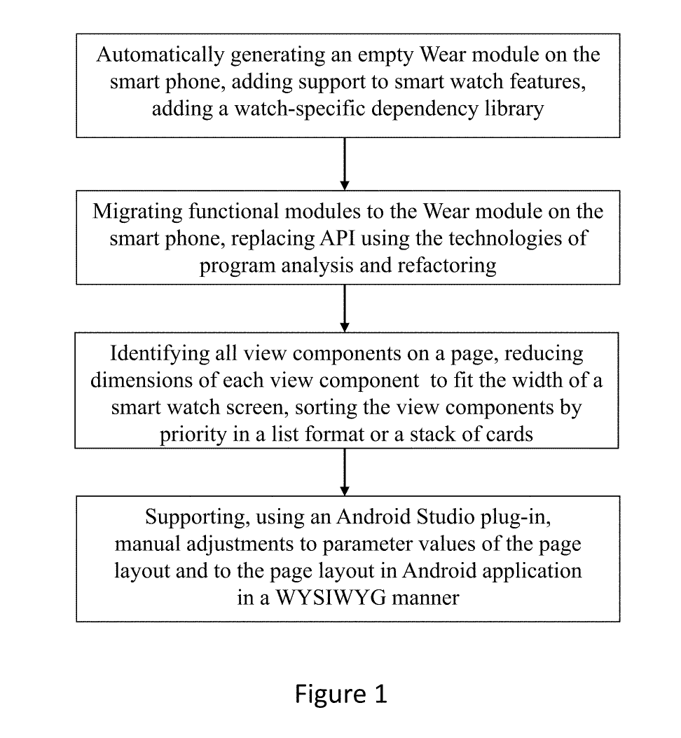

This section with a popular Android application “2048 Game” (https://github.com/plter/Android2048GameLesson) as an example for smart watch application refactoring. The processing method of the process shown in FIG. 1. The 2048 game is a puzzle game, with a 16 grid on the initial page. When two squares are placed with two number 2, the rules of its operation allow a user to slide up and down, or left and right. In each slide, numbers in all squares are compressed closer; the system will also generate random numbers in blank squares. Adjacent squares of the same number are merged and the numbers are added in the new square. Continued merging of the squares and addition of the numbers may lead to a final piece having 2048, which leads to the success of the game.

First, the source code structure of the Android game 2048 is automatically adjusted. A Wear module having empty Activity is added, and AndroidManifest.xml file is modified to add support for the watch's features (<uses-feature android: name=“android.hardware.type.watch”/>), and dependency library files (com.google.android.support:wearable and com.google.android.gms:play-services-wearable) are added. After the layout file of the original Android applications and functions associated with the layout files are migrated from the Mobile folder to the Wear module, program analysis tools are used to analyze APIs in the Android system application calls, and then replacing the APIs. For example, Notification.Builder is replaced with NotificationCompat.Builder. On some mobile phones, the API have unique characteristics and they are replaced by remote calling method (e.g. via Bluetooth communication), by calling the corresponding method in the Mobile module (folder) on the mobile phone side and receiving a return value.

Next, the pages are adapted. This example reduces each view component in custom layout and textView in accordance with the size proportion of the phone to watch. Since the width and the height of each square in the 2048 Game is hardcoded in the code, the dimensions need to be manually adjusted to fit the watch's screen size. In addition, the default watch sliding exit must be disabled, otherwise it will conflict with the sliding operation of the game, which requires modification of the styles.xml file by adding <item name=“android:windowSwipeToDismiss”>false</item>. The exit operation can be achieved by a long press, which only requires adding a long-press call back function for executing exit in the layout file.

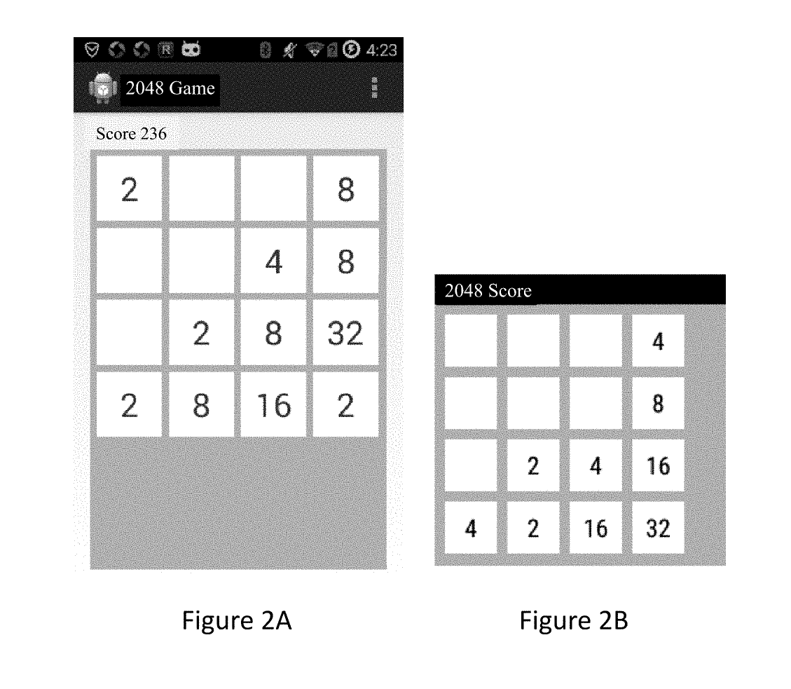

Finally, the Mobile module is compiled and packaged with the Wear module to generate an APK file for a smart watch equipped with the Android Wear system. The refactored application is also placed on github (https://github.com/ymifa/jike_wear2048) FIGS. 2A and 2B are screenshots of the 2048 game on a smart phone and a smart watch respectively.

What is claimed is:

1. A method of refactoring Android applications for smart watches, comprising:
1) for a given Android application, creating an empty folder Mobile, migrating source codes of the Android application to the Mobile folder, and automatically generating a Wear module in a root of the Android application;
2) adding codes to support smart watch features in the Wear module, and adding a watch-specific dependency library; and copying the source codes of the Android application to the Wear module;
3) replacing API in source codes of the Android application copied into the Wear module by an API suitable for Android Wear for smart watches; and
4) reducing page layout of the Android application by a reduction ratio corresponding to size ratio of a smart phone to a smart watch; identifying all view components on a page of the Android application, reducing down to a dimension of each of the view components to fit a screen width of the smart watch, and sorting the view components based on priorities.

2. The method of claim 1, wherein in step 2) if the source codes of the Android application copied into the Wear module include an API that cannot be replaced by an API suitable for Android Wear for smart watches, step 2) further comprises:
calling a corresponding API in the Mobile folder; and
replacing the API in the Wear module by using returned value of the corresponding API.

3. The method of claim 1, wherein after the step of sorting, the view components are displayed in a list format or in a stack of cards.

4. The method of claim 3, further comprising:
supporting, with an Android Studio plug-in, manual adjustments to parameter values of the page layout and to the page layout in Android application in a WYSIWYG manner.

5. The method of claim 1, wherein the view components are sorted by priority based on content relevance.

6. The method of claim 1, wherein the Mobile folder is created by opening the Android application using Android Studio tool.
